(19) United States
(12) Patent Application Publication
(10) Pub. No.: US 2016/0325410 A1
(43) Pub. Date: Nov. 10, 2016

(54) Apparatus for Setting Hardware

(71) Applicant: Robert Kenneth Love, JR., Clovis, NM (US)

(72) Inventor: Robert Kenneth Love, JR., Clovis, NM (US)

(21) Appl. No.: 15/146,857

(22) Filed: May 4, 2016

Related U.S. Application Data
(60) Provisional application No. 62/156,438, filed on May 4, 2015.

(51) Int. Cl. B25B 13/48; B25B 23/00; B25G 1/04; B25B 23/12; B25B 13/06

(52) U.S. Cl. CPC B25B 13/481; B25B 23/12; B25B 13/065; B25G 1/043; B25B 23/0035

(57) ABSTRACT

An apparatus for setting and starting hardware on all types of equipment includes a primary hardware setter and an extension arm. The primary hardware setter includes a primary shaft that is terminally connected to a primary handle. A primary socket is rotatably connected to the primary shaft opposite the primary handle through a distal shaft and is manipulated a turn knob and a turn belt. The turn knob is rotatably connected to the primary shaft through a proximal shaft and is positioned adjacent to the primary handle. The turn belt is trained around the proximal shaft and the distal shaft, wherein rotation of the turn knob is translated to the primary socket. The extension arm is perpendicularly attached to the primary socket and includes an extension socket that functions identically to the primary socket. The extension socket is positioned along an extension shaft that can be flexible or rigid.

The current application claims a priority to the U.S. Provisional Patent application Ser. No. 62/156,438 filed on May 4, 2015.

### FIELD OF THE INVENTION

The present invention relates generally to tool hardware. More specifically, the present invention is a tool intended to assist in the installation of nuts, bolts, washers, lock washers, etc.

### BACKGROUND OF THE INVENTION

Oftentimes when working on equipment, either when installing components or performing maintenance, hardware is located in hard to reach places. Mechanical systems such as car engines and aircraft, typically have limited access to certain areas where hardware needs to be installed or removed. Such areas can include awkward angles and tight spaces that are difficult for a user to reach by hand, especially when holding on to and attempting to set a piece of hardware, such as a nut, bolt, washer, etc. Due to these types of access constraints, it is common for hardware to be dropped before is able to be set in place. This can lead to foreign objects being left inside equipment, which can lead to damages, accidents, and other issues that both cost money and raise safety concerns. Furthermore, even tools can be dropped while trying to access limited spaces, wherein it is difficult to retrieve the tools in addition to the dropped hardware.

Therefore it is the object of the present invention to provide an apparatus that can be used set and start hardware on equipment in hard to reach areas. The present invention includes a primary hardware setter and an extension arm that can be used to place hardware in tough to reach places. The primary hardware setter has a primary socket that is used to retain the hardware magnetically or otherwise. The primary socket can be configured to be used with any type of hardware such as nuts, bolts, washers, cotter keys, aircraft hardware, etc. A socket rotation assembly allows a user to turn the primary socket in order to start the hardware in addition to setting the hardware. The extension arm can be attached to the primary socket in order to reach spaces at different angles, and includes an extension socket that functions the same as the primary socket, wherein the extension arm can be rotated via the primary socket. In addition to setting and starting hardware, the magnetic nature of the present invention allows the present invention to be used to retrieve lost hardware or tools.

### BRIEF DESCRIPTION OF THE DRAWINGS

FIG. 1 is a perspective view of the extension arm being attached to the primary hardware setter, wherein the extension shaft is configured to be flexible.

FIG. 2 is a front elevational view of the primary hardware setter, wherein the turn belt is positioned within the proximal groove and the distal groove and is frictionally engaged with the proximal shaft and the distal shaft.

FIG. 3 is a front elevational view of the primary hardware setter, wherein the turn belt is removed to show the proximal groove and the distal groove.

FIG. 4 is a perspective detail view of the primary socket, wherein the primary socket is a single, solid magnet.

FIG. 5 is a perspective detail view of the primary socket, wherein the primary threading is positioned within the primary socket, and wherein the primary magnet is terminally positioned opposite the primary shaft.

FIG. 6 is a perspective detail view of the primary socket, wherein the primary cavity is tiered to receive multiple types of hardware.

FIG. 7 is a front elevational view of the extension arm, wherein the extension shaft is rigid.

FIG. 8 is a perspective detail view of the extension socket, wherein the extension socket is a single, solid magnet.

FIG. 9 is a perspective detail view of the extension socket, wherein the extension threading is positioned within the extension socket, and wherein the extension magnet is terminally positioned opposite the extension shaft.

FIG. 10 is a perspective detail view of the extension socket, wherein the extension cavity is tiered to receive multiple types of hardware.

### DETAIL DESCRIPTIONS OF THE INVENTION

All illustrations of the drawings are for the purpose of describing selected versions of the present invention and are not intended to limit the scope of the present invention.

The present invention is an apparatus for setting and starting hardware on all types of equipment. The present invention can be used to set and start hardware that includes, but is not limited to, nuts, bolts, washers, and lock washers. Furthermore, the present invention can be used to start a single piece of hardware or multiple pieces of hardware at the same time. In addition to setting and starting hardware in hard to reach locations, the present invention can be used to retrieve tools and hardware that are dropped in hard to reach places.

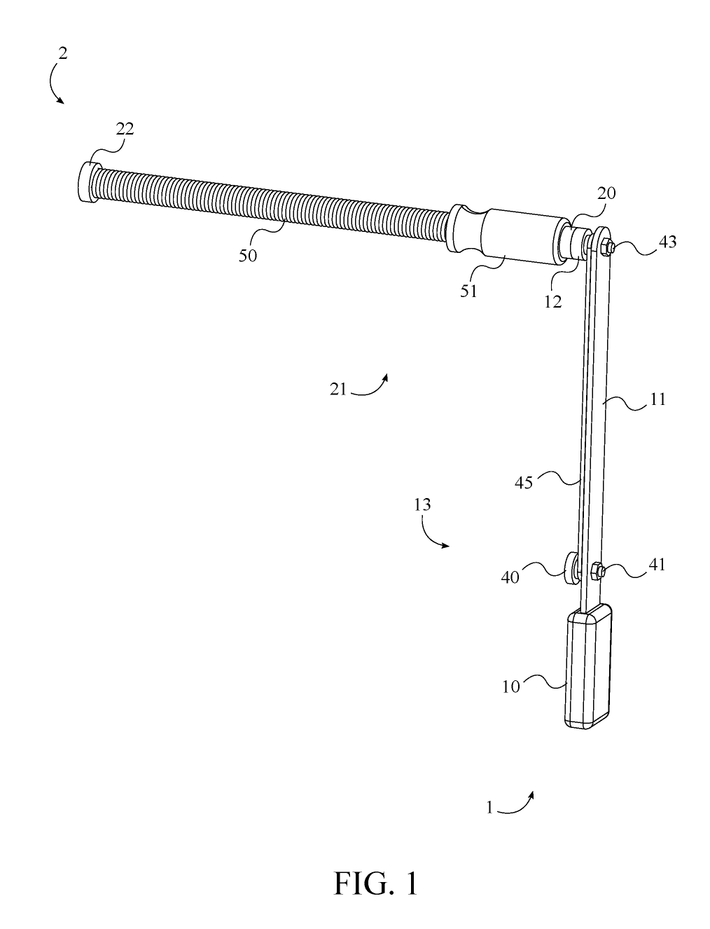

In reference to FIG. 1, the present invention comprises a primary hardware setter 1 and an extension arm 2 that are used to start hardware. The primary hardware setter 1 can be used standalone or in conjunction with the extension arm 2. The primary hardware setter 1 is an elongated structure that is used to start hardware in hard to reach place, such as tight spaces where an arm cannot reach. The extension arm 2 is terminally attached to the primary hardware setter 1 and provides a perpendicular extension that is used to access spaces that could otherwise not be reached.

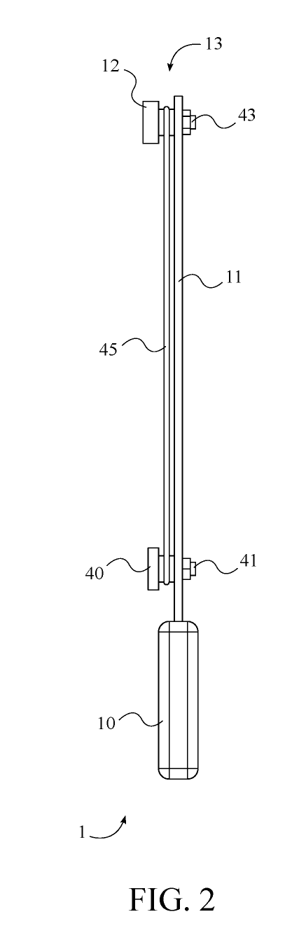

In reference to FIG. 2, the primary hardware setter 1 comprises a primary handle 10, a primary shaft 11, a primary socket 12, and a socket rotation assembly 13. The primary handle 10 is the portion of the primary hardware setter 1 that is held by a user, while the primary shaft 11 extends from the primary handle 10 providing the elongated nature of the primary hardware setter 1, wherein the primary handle 10 is terminally connected to the primary shaft 11. The primary socket 12 is terminally positioned on the primary shaft 11 opposite the primary handle 10 and provides the means for retaining the hardware such as nuts, washers, etc.

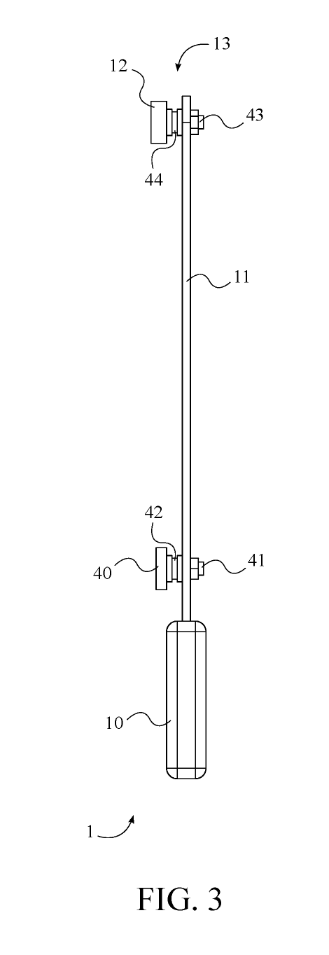

In further reference to FIG. 2-3, the socket rotation assembly 13 comprises a turn knob 40, a proximal shaft 41, a distal shaft 43, and a turn belt 45. Both the proximal shaft 41 and the distal shaft 43 are rotatably connected to the primary shaft 11, wherein the proximal shaft 41 is positioned adjacent to the primary handle 10 and the distal shaft 43 is terminally positioned on the primary shaft 11 opposite the primary handle 10. The turn belt 45 is trained around the proximal shaft 41 and the distal shaft 43, such that when the proximal shaft 41 is rotated so is the distal shaft 43. More specifically, the proximal shaft 41 comprises a proximal groove 42, while the distal shaft 43 comprises a distal groove 44, wherein the turn belt 45 is positioned into the proximal groove 42 and the distal groove 44 and is frictionally engages the proximal shaft 41 and the distal shaft 43.

In further reference to FIG. 2-3, the turn knob 40 is terminally connected to the proximal shaft 41 and provides a means for manipulating the proximal shaft 41. The turn knob 40 has a textured lateral surface that allows a user to readily grasp the turn knob 40 and rotate the turn knob 40 in both a clockwise and counterclockwise direction. Meanwhile, the primary socket 12 is terminally connected to the distal shaft 43. When the user rotates the turn knob 40, the proximal shaft 41 is rotated, which in turn rotates the distal shaft 43 and the primary socket 12 via the turn belt 45. As such, when hardware is attached to the primary socket 12, the turn knob 40 can be used to rotate the primary socket 12 in order to set the hardware in place.

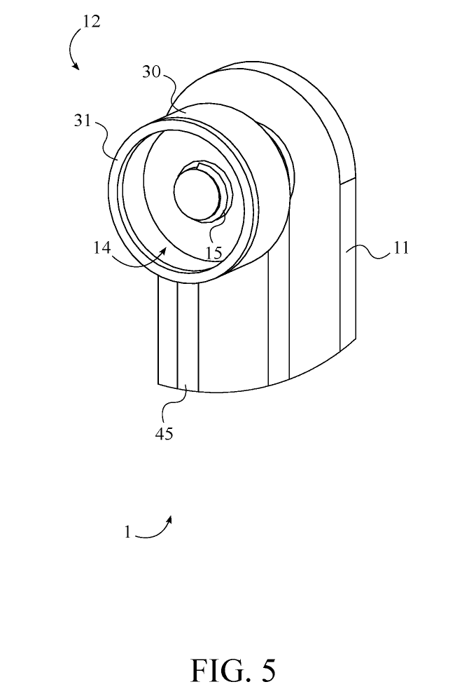

The primary socket 12 can be designed in a number of ways to retain the desired piece(s) of hardware. In some embodiments of the present invention, a primary cavity 14 is formed in a primary body 30 of the primary socket 12 and a primary threading 15 is positioned within the primary socket 12, as depicted in FIG. 5. A piece of hardware, such as a nut, can be partially threaded onto the primary threading 15 in order to retain the hardware in position within the primary socket 12. When the primary socket 12 is rotated, the hardware is started on the object to which the hardware is being secured and the hardware is disengaged from the primary threading 15.

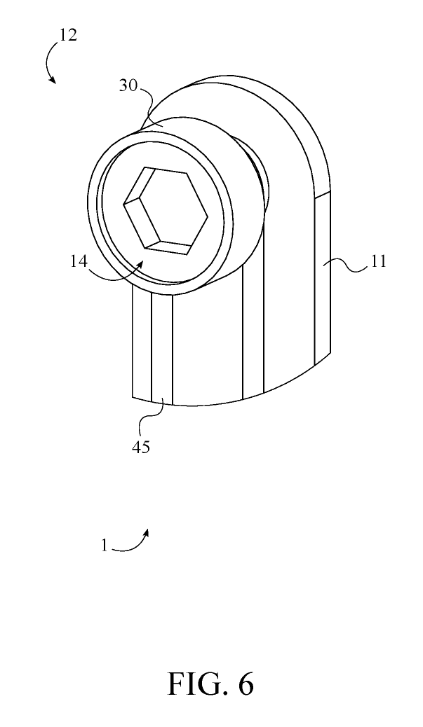

The primary cavity 14 may also be designed to match the lateral profile of the hardware in order to retain the hardware within the primary socket 12. For example, if the hardware is a nut, then the primary cavity 14 can be designed having a hexagonal shape in order to receive the nut, wherein the nut is fit snuggly within the primary cavity 14. The primary cavity 14 may also have a tiered profile, such that multiple hardware types can be set at one time, as depicted in FIG. 6. For example, the primary cavity 14 might have an inner profile that is hexagonal to receive a nut and an outer profile that is circular to receive a washer; the nut being positioned into the primary cavity 14 first, followed by the washer. In some embodiments, the primary socket 12 may further be magnetized in order to better retain the hardware, while also allowing hardware to be attached to the end of the primary socket 12 outside of the primary cavity 14.

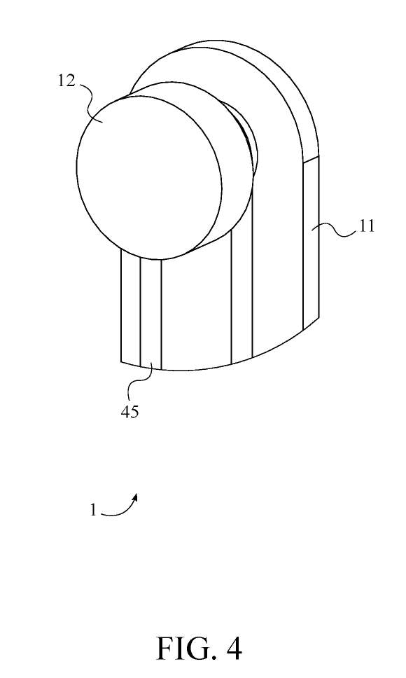

In other embodiments of the present invention, the primary socket 12 comprises a primary magnet 31. In reference to FIG. 5, the primary magnet 31 is terminally positioned opposite the distal shaft 43 and allows hardware to be magnetically coupled to the end of the primary socket 12. The primary magnet 31 can be permanently fixed to the primary body 30 of the primary socket 12, or removably attached to the primary body 30 depending on the embodiment and the intended application of the present invention. The primary magnet 31 may have an opening to allow some hardware to be positioned within the primary cavity 14, while allowing other hardware to be magnetically attached to the end of the primary socket 12. In yet other embodiments, the primary socket 12 is simply a single solid magnet, as depicted in FIG. 4.

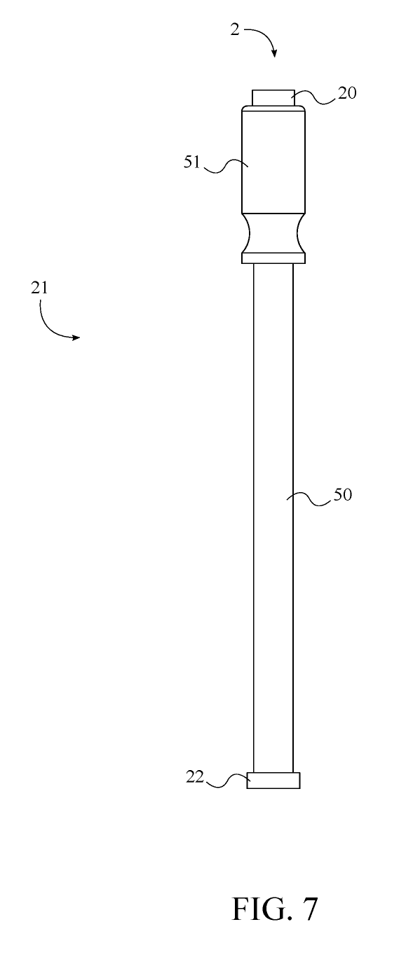

In reference to FIG. 7, the extension arm 2 comprises a connector 20, an extension shaft 21, and an extension socket 22. The connector 20 is adjacently attached to the primary socket 12, wherein the connector 20 allows the extension arm 2 to be detached from the primary hardware setter 1. The extension shaft 21 is adjacently connected to the connector 20 opposite the primary socket 12, wherein the extension shaft 21 extends away from the connector 20. Meanwhile, the extension socket 22 is terminally connected to the extension shaft 21 opposite the connector 20. Similar to the primary socket 12, the extension socket 22 provides the means for retaining the hardware such as nuts, washers, etc.

In reference to FIG. 1, the connector 20 provides a fixed position connection in relation to the primary socket 12, such that as the primary socket 12 is rotated, the extension arm 2 is turned at the same rate. When the user rotates the turn knob 40, the extension arm 2 is rotated via the primary socket 12 and the socket rotation assembly 13. As such, when hardware is attached to the extension socket 22, the turn knob 40 can be used to rotate the extension socket 22 in order to set the hardware in place. The connector 20 is attached to the primary socket 12 opposite the primary shaft 11 and is preferably attached to the primary socket 12 through a magnetic bond, wherein the connector 20 is a magnet; the primary socket 12 may either be magnetized or comprise the primary magnet 31. However, it is possible for the connector 20 to be attached to the primary socket 12 using any other means, such as a snap connection, threaded connection, etc.

The connector 20 also allows for the extension arm 2 to be interchanged with the primary hardware setter 1. In some instances the length of the extension arm 2 that is required may vary. By using the connector 20, the extension arm 2 can readily be interchanged in order to utilize the extension shaft 21 of the appropriate length. In the preferred embodiment of the present invention, the extension shaft 21 is flexible as depicted in FIG. 1, allowing the extension shaft 21 to be maneuvered around various interfering objects. Preferably, a flex coil spring is utilized, wherein the extension shaft 21 is able to bend in a number of different directions and different angles, yet is able to remain linear when no lateral force is applied to the extension shaft 21. In other embodiments, the extension shaft 21 is rigid as depicted in FIG. 7, being unable to flex in any direction, and remains perpendicular to the primary hardware setter 1.

In some embodiments of the present invention, the extension arm 2 is configured to be used independent of the primary hardware setter 1, wherein the extension shaft 21 comprises a stem 50 and an extension handle 51 as depicted in FIG. 7. The extension handle 51 allows the extension arm 2 to be held by the user, while the stem 50 extends from the extension handle 51 providing the elongated nature of the extension shaft 21. The stem 50 and the connector 20 are terminally connected to the handle, wherein the stem 50 and the connector 20 are positioned opposite each other along the handle. Meanwhile, the extension socket 22 is terminally connected to the stem 50 opposite the handle. By grasping the extension handle 51, the user can manipulate the stem 50 and the extension socket 22 in order to set hardware in place.

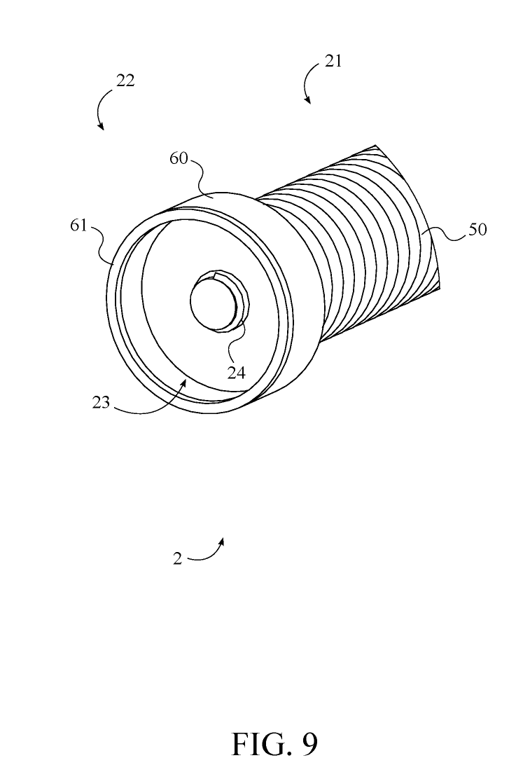

Similar to the extension socket 22, the extension socket 22 can be designed in a number of ways to retain the desired piece(s) of hardware. In some embodiments of the present invention, an extension cavity 23 is formed in an extension body 60 of the extension socket 22 and an extension threading 24 is positioned within the extension socket 22, as depicted in FIG. 9. A piece of hardware, such as a nut, can be partially threaded onto the extension threading 24 in order to retain the hardware in position within the extension socket 22. When the extension socket 22 is rotated, the hardware is started on the object to which the hardware is being secured and the hardware is disengaged from the extension threading 24.

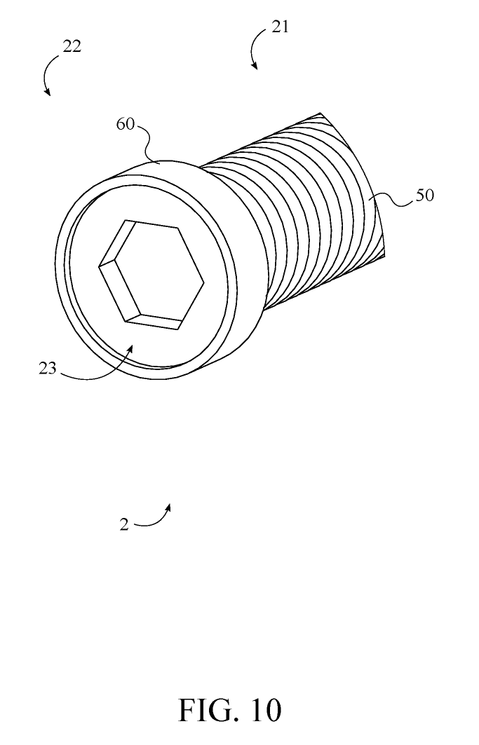

The extension cavity 23 may also be designed to match the lateral profile of the hardware in order to retain the hardware within the extension socket 22. For example, if the hardware is a nut, then the extension cavity 23 can be designed having a hexagonal shape in order to receive the nut, wherein the nut is fit snuggly within the extension cavity 23. The extension cavity 23 may also have a tiered profile, such that multiple hardware types can be set at one time, as depicted in FIG. 10. For example, the extension cavity 23 might have an inner profile that is hexagonal to receive a nut and an outer profile that is circular to receive a washer; the nut being positioned into the extension cavity 23 first, followed by the washer. In some embodiments, the extension socket 22 may further be magnetized in order to better retain the hardware, while also allowing hardware to be attached to the end of the extension socket 22 outside of the extension cavity 23.

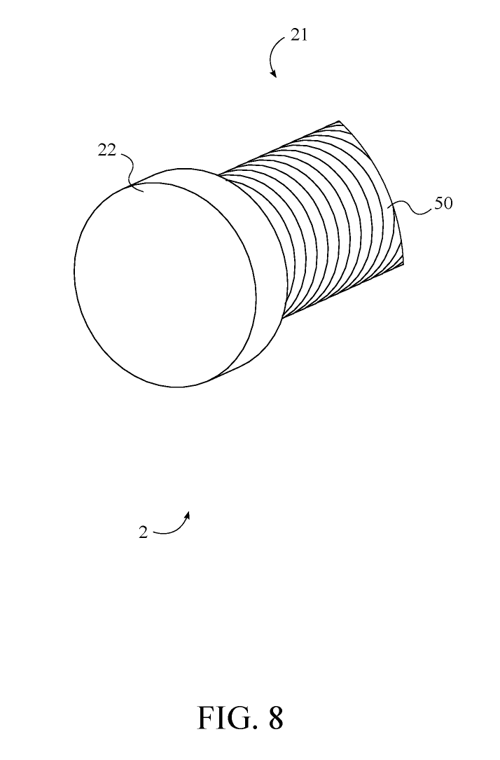

In other embodiments of the present invention, the extension socket 22 comprises an extension magnet 61. In reference to FIG. 9, the extension magnet 61 is terminally positioned opposite the distal shaft 43 and allows hardware to be magnetically coupled to the end of the extension socket 22. The extension magnet 61 can be permanently fixed to the extension body 60 of the extension socket 22, or removably attached to the extension body 60 depending on the embodiment and the intended application of the present invention. The extension magnet 61 may have an opening to allow some hardware to be positioned within the extension cavity 23, while allowing other hardware to be magnetically attached to the end of the extension socket 22. In yet other embodiments, the extension socket 22 is simply a single solid magnet, as depicted in FIG. 8.

Although the invention has been explained in relation to its preferred embodiment, it is to be understood that many other possible modifications and variations can be made without departing from the spirit and scope of the invention as hereinafter claimed.

What is claimed is:

1. An apparatus for setting hardware comprises:
a primary hardware setter;
the primary hardware setter comprising a primary handle, a primary shaft, a primary socket, and a socket rotation assembly;
the socket rotation assembly comprising a turn knob, a proximal shaft, a distal shaft, and a turn belt;
the primary handle being terminally connected to the primary shaft;
the proximal shaft and the distal shaft being rotatably connected to the primary shaft;
the proximal shaft being positioned adjacent to the primary handle;
the distal shaft being terminally positioned on the primary shaft opposite the primary handle;
the turn belt being trained around the proximal shaft and the distal shaft;
the turn knob being terminally connected to the proximal shaft; and
the primary socket being terminally connected to the distal shaft.

2. The apparatus for setting hardware as claimed in claim 1 comprises:
an extension arm comprising a connector, an extension shaft, and an extension socket;
the connector being adjacently attached to the primary socket;
the extension shaft being adjacently connected to the connector opposite the primary socket; and
the extension socket being terminally connected to the extension shaft opposite the connector.

3. The apparatus for setting hardware as claimed in claim 2 comprises:
the extension shaft comprising a stem and a handle;
the stem and the connector being terminally connected to the handle;
the stem and the connector being positioned opposite each other along the handle; and
the extension socket being terminally connected to the stem opposite the handle.

4. The apparatus for setting hardware as claimed in claim 2, wherein the extension shaft is flexible.

5. The apparatus for setting hardware as claimed in claim 2, wherein the extension shaft is rigid.

6. The apparatus for setting hardware as claimed in claim 2, wherein the connector is a magnet.

7. The apparatus for setting hardware as claimed in claim 2, wherein the extension socket is magnetized.

8. The apparatus for setting hardware as claimed in claim 2 comprises:
the extension socket comprising an extension magnet; and
the extension magnet being terminally positioned opposite the extension shaft.

9. The apparatus for setting hardware as claimed in claim 2 comprises:
an extension threading being positioned within the extension socket.

10. The apparatus for setting hardware as claimed in claim 1, wherein the primary socket is magnetized.

11. The apparatus for setting hardware as claimed in claim 1 comprises:
the primary socket comprising a primary magnet; and
the primary magnet being terminally positioned opposite the distal shaft.

12. The apparatus for setting hardware as claimed in claim 1 comprises:
the proximal shaft comprising a proximal groove;
the distal shaft comprises a distal groove;
the turn belt being positioned into the proximal groove and the distal groove; and
the turn belt frictionally engaging the proximal shaft and the distal shaft.

13. The apparatus for setting hardware as claimed in claim 1 comprises:
a primary threading being positioned within the primary socket.
